(19) United States
(12) Patent Application Publication
(10) Pub. No.: US 2021/0217028 A1
(43) Pub. Date: Jul. 15, 2021

(54) METHOD AND SYSTEM FOR THE CERTIFICATION OF A PRODUCT TO BE SHIPPED

(71) Applicant: CERTILOGO S.P.A., Milano (IT)

(72) Inventor: Michele Casucci, Milano (IT)

(73) Assignee: CERTILOGO S.P.A., Milano (IT)

(21) Appl. No.: 15/733,844

(22) PCT Filed: May 31, 2019
(86) PCT No.: PCT/IB2019/054525

§ 371 Date: Nov. 30, 2020

(30) Foreign Application Priority Data
Jun. 1, 2018 (IT) 102018000005963

(51) Int. Cl. G06Q 30/00; G06Q 10/08; G06K 19/07

(52) U.S. Cl. CPC G06Q 30/0185; G06K 19/0723; G06Q 10/0838

(57) ABSTRACT

The present invention relates to a method and a system for the certification of a product to be shipped wherein the latter is associated with a tag meant to be queried by several devices before and after shipment to determine whether the data contained therein remain unchanged after the shipment of the product.

### TECHNICAL FIELD

The present invention relates to a method and a system for the certification of a product to be shipped, more specifically, for the certification of not certified at origin products for sale or products already sold at least once.

### BACKGROUND ART

In the following description and subsequent claims, a “not certified at origin” product means a product or article which has not been associated with any type of labeling or authentication device prior to its shipment. “Products already sold at least once” instead means those products or articles already placed on the market, therefore equipped with labeling or similar authentication/certification devices, but intended for further sale; think for example of all those articles which are part of the so-called “second-hand market” the owner of which is no longer the producer but the first buyer.

Generally, several certification/authentication systems are known to determine the originality of a product.

One solution is, e.g., to associate with the product devices, or in any case elements, which permit determining whether the product is intact and/or never before used. Such solution, however, is only effective for certain types of products, such as, e.g., edible products, and has the drawback of not being applicable to products already placed on the market at least once.

The Applicant has become aware that the exchange of products between a seller and a buyer is often exposed to potential risks of fraud in both online and off-line circuits. For example, in the event of a buyer wanting to buy a product in a digital shop, the possibility of receiving counterfeit goods increases considerably as the buyer is unable to verify the product directly.

The Applicant has further become aware that even if the product is at first glance identifiable as original, there are in fact no solutions to verify its authenticity except by contacting the manufacturer of the product or an expert and asking for specific investigations.

### DESCRIPTION OF THE INVENTION

The Applicant has thus thought of a solution which allows a buyer to independently determine the authenticity of the purchased products so as to avoid receiving counterfeit products which would result in consequential economic damage and waste of time.

The Applicant has further thought of a certification which can also be associated with the product by the seller so as to also make the phase before the shipment of the product independent.

The Applicant has therefore developed a method and system for the certification of a product to be shipped wherein the latter is associated with a tag meant to be queried by several devices before and after shipment to determine whether the data contained therein remain unchanged after the shipment of the product.

The present invention therefore relates, in a first aspect thereof, to a method for the certification of a product to be shipped according to claim 1.

In a further aspect, the present invention relates to a system for the certification of a product to be shipped according to claim 8.

### BRIEF DESCRIPTION OF THE DRAWINGS

Other characteristics and advantages of the method and system for the certification of a product to be shipped according to the present invention will be more evident from the following description of the preferred, but not exclusive, embodiments thereof, illustrated by way of an indicative, but non-limiting example, with reference to the attached tables of drawings in which:

FIG. 1 shows a generic operational block diagram of a system for the certification of a product to be shipper in accordance with the present invention,

FIG. 2 shows a view of the product of FIG. 1 with which an electronic identification device is associated.

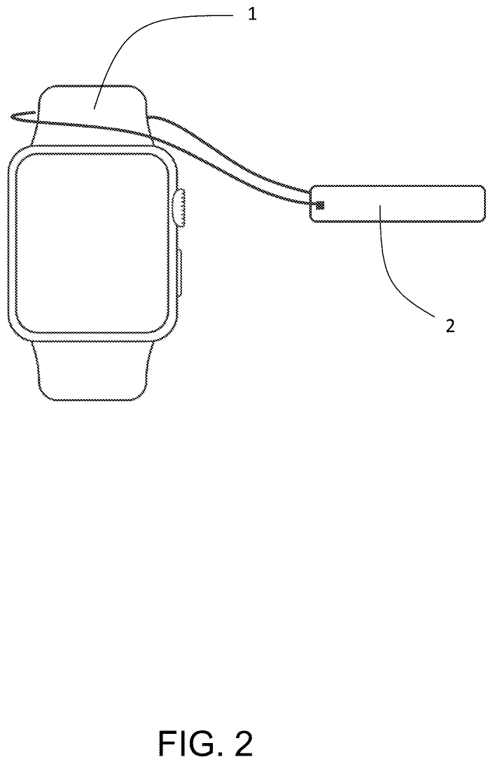

### EMBODIMENTS OF THE INVENTION

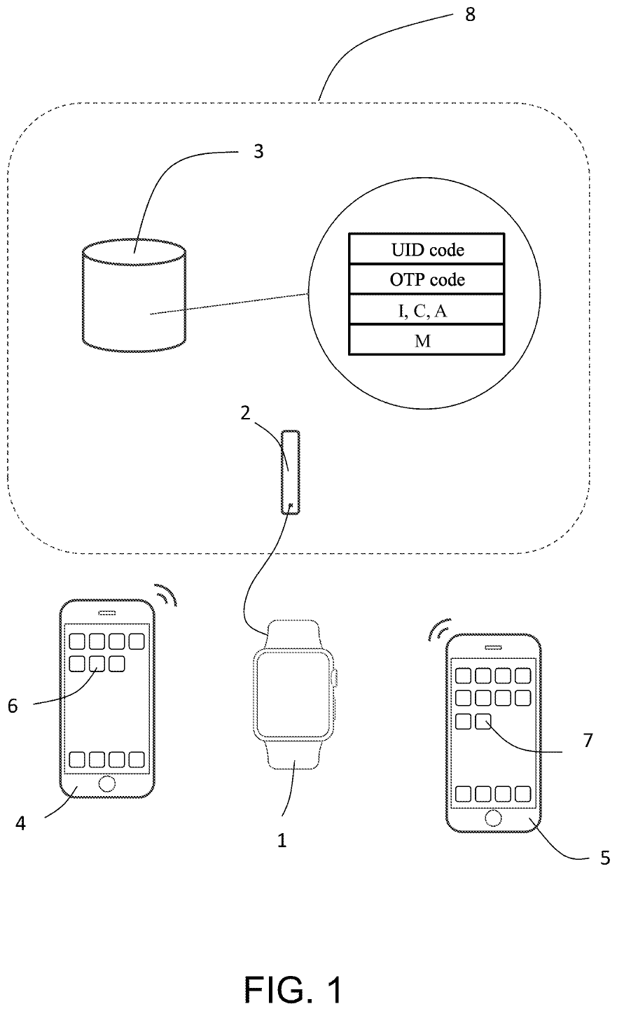

With particular reference to FIG. 1, reference numeral 1 globally indicates a system for the certification of a product 1 according to the present invention.

The product 1 may comprise any type of goods or items, such as, e.g., clothing, watches, toys, furniture items, etc., intended for sale and shipment by purchase, preferably via an online platform.

The product 1 is usefully associated with an electronic identification device 2, e.g., a tag.

Preferably, the tag 2 is of the type with Near Field Communication (or “NFC”) technology and comprises at least one memory and one antenna. The memory contains at least one unique identification code UID (“Unique Identifier”) which is transmitted via the antenna and can therefore be read by one or more querying devices.

The memory of the NFC tag 2 can also contain at least one One-Time password (or “OTP”) code which is transmitted via the antenna and can therefore be read by the querying devices.

“One-Time Password” code means a single-use or temporary password which is generated and used for a single transaction. Because such passwords cannot be stored by users, the generation of a single-use password may preferably require the user to be in possession of a security token. The token is a device (generally physical but which could also be virtual or implemented only through software) designed to authenticate the user to the certification entity as explained in detail in the rest of the present description.

In a preferred embodiment, the OTP code is obtained each time the chip is solicited, e.g. through the antenna as a result of an instantaneous calculation operation between a time stamp, the UID code and a randomizer. The UID code, preferably not encrypted, is stored in a server 3 of the system while the OTP code (disposable) is controlled in its integrity by appropriate processing means to authenticate any operations made by users on the server. It should be noticed that the OTP code does not constitute any “index” or “unique key” to which to link certain information as its content comprises a volatile and constantly evolving value.

The NFC tag 2 can have a reduced-thickness shape so that it can be directly associated with the product 1, e.g., by gluing. Furthermore, the NFC tag 2 may comprise “tamper-evident” technology security elements in order to visually verify whether the tag has been tampered with or removed.

In one version, the NFC tag 2 can be an object in its own right and can be secured to the product by means of tamper-evident security links of a known type.

As mentioned above, the system comprises a server 3 containing the data contained in the NFC tag 2 in data structures adapted to store, in particular, the UID and OTP codes for subsequent query and/or update as will be specified in detail in the remainder of the present description.

For this purpose, the system comprises at least one initial querying device 4 intended to communicate with the NFC tag 2 in order to receive the UID and OTP identification codes.

The querying device 4 may comprise a smartphone designed to communicate by means of NFC technology with tag 2 in order to receive the data and information contained therein.

It should be noticed that the system according to the invention requires that the NFC tag 2 and the server 3 be owned by a certification entity 8. The certification entity 8 therefore contains all the data and information stored in the NFC tag 2. In particular, a unique correspondence exists between the UID and OTP codes present in the NFC tag 2 and those saved in the server 3. Basically, before a possible shipment of the product, the UID and OTP codes of the NFC tag 2 and those saved in the server 3 contain the same values.

When a user seller, previously accredited by the certification entity 8, has to proceed with the shipment of the product 1, he/she first of all secures the NFC tag 2 to the product 1.

According to one embodiment, preferably, the certification entity 8 does not know the UID and OTP codes of the NFC tag 2.

According to a further version, the UID and OTP codes of the NFC tag 2 do not contain information about the product 1 (such as, e.g., type, model, brand, etc.). After the NFC tag 2 has been attached to the product 1, the seller queries the NFC tag 2 by means of the first querying device 4, by bringing the device 4 closer to receive the information contained in it, by means, e.g., of NFC technology, and then receives the UID and OTP codes. For this purpose, the querying device 4 is equipped with its own front-end subsystem 6 (e.g. an app) to enable the device 4 to be connected to the server 3.

In accordance with a preferred embodiment, the front-end subsystem 6 enables the seller to accredit itself (by means, for example, of an email and password or other accreditation data) and to store a variety of information I about the product 1 (e.g., type, model, brand, etc.). This way, an association is made between the UID and OTP codes of the NFC tag 2 and the product 1.

In one embodiment, the front-end subsystem 6 also makes it possible to store photographic information I on the product 1 taken by means of the device 4 so as to store it on the server 3. In essence, before sending the product 1 to the buyer, the seller will take a variety of photographs, both panoramic and possibly detailed with its smartphone 4 by means of the front-end subsystem 6. For example, if the product to be shipped is a bag, it may be necessary to photograph handles, seams, fasteners, as well as photograph general views (view of the whole, side, front, etc.). In addition, descriptive information I such as product codes, certificates, distinguishing marks, etc. may also be associated with each product 1. In this case, the seller will manually enter said descriptive information I by means of the front-end subsystem 6 intended to be stored on the server 3.

Advantageously, the system according to the invention has appropriate processing means (not shown) in signal communication with the server 3 and with the device 4 to generate at least one association code C intended to associate the information I to the UID and/or OTP codes of the NFC tag 2 and the product 1. Preferably, the association code C is saved on the server 3 and is available for subsequent queries. It follows that the seller and/or the buyer can associate one or more photographs to the product 1 thanks to the association code C saved on the server 3.

Preferably, as explained in detail in the remainder of the present description, a buyer can receive on his or her device 5 a preview of the photo and/or of the information I relating to the product 1 (e.g., by email or notification via app) and generate at his or her discretion a conditional approval to be sent to the certification entity 8.

As specified above, before shipping the product 1 for sale, a series of operations are actually carried out which not only make it possible to associate the NFC tag 2 (which will always travel with the product 1) with the product itself, but also to associate a series of information I with the product 1 through the data saved on the server 3.

It must be specified that the certification entity 8 is adapted to monitor all the information and data stored in the server 3 and exchanged between the seller and the buyer. This way, the certification entity 8 can intervene to validate or invalidate the sale and/or purchase process at any time. For this purpose, the certification entity 8 can use one or more predefined algorithms, also programmed to work in automatic learning (or so-called “machine learning” or “deep learning”), wherein a plurality of potentially possible events is simulated during the sale and/or purchase operations. In particular, the computer 5 is able to generate its own learning model which permits automatically recognizing the products P and, furthermore, increasing the level of learning on the basis of training previously carried out in the factory. In the remainder of this description the phases are listed which permit a buyer to determine whether the received product 1 is really the one dispatched.

In this case, when a buyer (preferably previously accredited by the certification entity 8) receives the product 1, he or she first queries the NFC tag 2 to receive the UID and OTP codes stored in its memory. For this purpose, the system in accordance with the invention comprises a second device 5 communicating with the server 3 and usable by the buyer. The device 5 is preferably a smartphone completely identical to the first device 4, which also has its own front-end subsystem 7.

In one embodiment, the front-end subsystems 6, 7 of each device are part of a single subsystem with substantially identical interfaces to enable users to perform similar operations. In an alternative embodiment, the front-end subsystem 6 of the first device 1 has different characteristics from the front-end subsystem 7 of the second device 5; for example, the latter may permit operations limited or unnecessary for the buyer in order to advantageously speed up the query and certification system.

After the buyer has queried the NFC tag 2, the second device 5 receives the UID and OTP codes stored in it. At that point the second device 5 communicates with the server 3 and by means of the processing means a comparison is made of the UID and OTP codes to determine whether such codes correspond to those stored in the server during the querying of the NFC tag 2 with the first device 4 by the seller.

Furthermore, the buyer is invited to make sure that the photographic and descriptive information I of the product 1 corresponds to the received product. In essence, the buyer, by connecting through his or her front-end subsystem 7, can display, in the device 5, the information I entered by the seller, stored in the server 3 and monitored by the certification entity 8.

If, following the second query with the second device 5, there is no correspondence between the information I and/or the UID and OTP codes saved in the server 3 and those read by the second device 5, the latter will emit an error message via the front-end subsystem 7. It follows that the buyer is informed about the possible non-originality of the product 1 and/or tampering with the NFC tag 2.

Diversely, if the query operations carried out by the buyer with the second device 5 are successful, and therefore there is correspondence between the information I and/or the UID and OTP codes for the verification of the product 1, the buyer is authorized to confirm the correct outcome of the control operation through the front-end subsystem 7 and to remove the NFC tag 2.

It should be noticed that the certification entity 8 may comprise a closed telecommunications network wherein the data are only accessible to authorized users. For this purpose, the certification entity 8 generates an access key A to allow each device 4, 5 to be able to communicate with the server 3. Usefully, the access keys A for each respective querying device 4, 5 are preferably saved on the server 3.

Advantageously, the front-end subsystem 6, 7 allows accredited users to further have a plurality of multimedia contents M saved on the server 3 and produced by the certification entity 8. “Multimedia content” means an information content comprising a plurality of texts, images, sounds, animations and/or videos related to the product 1 and generated by the certification entity 8. In particular, the devices 4, 5 are configured to make the user use the multimedia contents M in a visual format, e.g., through a display, or in an audio format through a sound emitter.

Preferably, each front-end subsystem 6, 7 comprises a browser and/or an app to allow users to interact with the NFC tag 2 and use the multimedia contents M saved on the server 3.

Usefully, the querying devices 4, 5 each comprise a user interface, e.g., a graphic interface, for the simultaneous use of the multimedia content M, of the information I related to the product and of one's own user profile. In such case, it is possible to make use of a web browser connected via the Internet to the server 3 and adapted to load a web page to be displayed on one's own device 4, 5 and access one's own accredited profile.

According to an alternative embodiment, the authorizing access key A could be replaced by a piece of biometric information (e.g., a fingerprint, an image of the iris, a photograph of the face, etc.) of the user which is processed by the device 4, 5.

In accordance with an embodiment which is not shown, the system according to the invention comprises an architecture of the “blockchain” type in signal communication with the server 3. The blockchain architecture allows the creation of a generally public register, immutable, distributed and not centralized, accessible with or without credentials on which to store the information about users, products and product transactions between users, protecting them with cryptographic validation techniques.

The method and the system for the certification of a product to be shipped in accordance with the invention have significant advantages.

First of all, the possibility of having the NFC tag to affix to the product 1 is only available to users accredited by the certification entity 8 thus ensuring a priori a guarantee of authenticity of the same product 1 to be sent both to sellers and to buyers.

Furthermore, in the event of the sold product 1 being identified as not in conformity with the original, the certification entity 8 can withdraw the access keys A thereby eliminating users who do not provide minimum requirements of authenticity for their products.

Finally, the present invention advantageously permits the certification of products intended for sale not only between two users, seller and buyer, but also for more complex sales architectures such as B2B, B2C or C2B.

As it has been possible to determine from the present description, it has been ascertained that the described invention achieves the intended objects and in particular the fact is underlined that by means of the method and the system for the certification of a product to be shipped, it is possible for users to verify the authenticity of a product independently, avoiding having to interface with external certification bodies for the verification of the products.

Moreover, thanks to the particular communication possible between the query devices, the front-end subsystems, the server and the NFC tags, fruition performances can be optimized both for public and private certifying bodies. The use of information between users as well as of multimedia contents can be carried out both on closed networks (e.g. intranet) and open networks (e.g. internet) accessible by anyone as long as they are accredited. The number of queries that can be combined with NFC tags is potentially endless and obviously an expert in the field can make numerous modifications and variations to the system and method described above, in order to satisfy contingent and specific needs, all of which are contained within the scope of protection of the invention, as defined by the following claims.

1) A method for a certification of a product to be shipped, comprising steps of:
a) providing a product,
b) providing an NFC tag comprising its own UID identification code and its own OTP code and which can be bound to said product,
c) providing a remote server wherein said UID identification code and said OTP code associated with said NFC tag are stored,
d) making a first query via a first querying device to said NFC tag to receive said UID code and said OTP code, and
e) making a second query via a second querying device to said NFC tag to check whether said UID code and said OTP code stored in said server remain unchanged after said first query.

2) The method according to claim 1, wherein the step d) of first query comprises the further steps of:
generating at least one piece of information identifying said product and storing it in said server,
associating the piece of information with said UID code and said OTP code to generate an association code, and
storing said piece of information and said association code in said server.

3) The method according to claim 2, wherein the step d) of first query comprises the further steps of:
photographing said product via the first querying device,
associating the photo taken of said UID code and said OTP code for updating said association code, and
storing said photo and said updated association code in said server.

4) The method according to claim 2, wherein the step e) of second query comprises the further steps of:
checking whether the association code generated in said first query corresponds to said association code stored in said server in said first query.

5) The method according to claim 1, wherein said steps b) and c) are performed by a certification entity provided with said server.

6) The method according to claim 5, wherein said certification entity generates an access key in order to make each querying device communicate with said server.

7) The method according to claim 6, wherein said first and second queries are carried out by means of a front-end subsystem accessible by said querying devices by means of said access key.

8) A system for a certification of a product, comprising:
a product intended for sale to which an NFC tag is bound having its own UID code and its own OTP code,
a server in which said UID code and said OTP code associated with said NFC tag are stored,
a first querying device intended for querying said NFC tag to receive said UID code and said OTP code, and
a second querying device intended for querying said NFC tag to check whether the UID code and the OTP code received correspond to said UID code and said OTP code stored in said server.

9) The system according to claim 8, comprising a certification entity provided with said server and adapted to generate an access key in order to make each querying device communicate with said server.

10) The system according to claim 9, wherein said querying devices comprise a front-end subsystem for accessing said server by means of said access key.

11) The method according to claim 3, wherein the step e) of second query comprises the further steps of:
checking whether the association code generated in said first query corresponds to said association code stored in said server in said first query.
